(19) United States
(12) Patent Application Publication
(10) Pub. No.: US 2017/0300260 A1
(43) Pub. Date: Oct. 19, 2017

(54) METHOD, DEVICE AND COMPUTER-READABLE STORAGE MEDIUM FOR DATA MIGRATION

(71) Applicant: Beijing Xiaomi Mobile Software Co., Ltd., Beijing (CN)

(72) Inventors: Zengxiang LV, Beijing (CN); Le WANG, Beijing (CN); Nan LI, Beijing (CN)

(73) Assignee: Beijing Xiaomi Mobile Software Co., Ltd., Beijing (CN)

(21) Appl. No.: 15/473,151

(22) Filed: Mar. 29, 2017

(30) Foreign Application Priority Data
Apr. 15, 2016 (CN) 201610236128.7

(51) Int. Cl. G06F 3/06

(52) U.S. Cl. CPC G06F 3/0623; G06F 3/0673; G06F 3/0604; G06F 3/0647

(57) ABSTRACT

The present disclosure provides a method, device and computer-readable storage medium for data migration. The method includes: triggering a data migration operation in a privacy space having a data migration right; receiving data selected to be migrated; and performing, by using a preset interface provided in the privacy space, the migration operation on the data to be migrated.

### CROSS-REFERENCE TO RELATED APPLICATION

This application is based on and claims priority to Chinese Patent Application No. 201610236128.7, filed Apr. 15, 2016, the entire contents of which are incorporated herein by reference in its entirety.

### TECHNICAL FIELD

The present disclosure generally relates to the technical field of terminals, and more particularly to a method, device and computer-readable storage medium for data migration.

### BACKGROUND

With the development of science and technology, a terminal, which can carry a multi-user operating system such as Android 5.0, becomes available. The multi-user operating system allows more than one account to be created on the same terminal, where the storage spaces corresponding to different account systems are isolated from each other, and each account system has access rights to data within its own storage space, but does not have access rights to storage spaces of other account systems without authorization. As such, the protection of user privacy is achieved. However, when an account system needs to manage the data in the storage space corresponding to another account system, data migration is required between the storage spaces corresponding to the two account systems.

When a user needs to migrate the data from a first space to a second space within a terminal, an additional storage device that is served as an intermediary is often needed, and a method may include: the data in a first space, which are to be migrated, is transmitted to an intermediary storage, which in turn transmits the data in the first space, which are to be migrated, from the intermediary storage device to a second space. The first space may be a storage space managed by a first account system, and the second space may be a storage space managed by a second account system. Such data migration method is complicated to operate, and a user can not directly migrate data between different account systems on a same terminal.

### SUMMARY

The present disclosure provides a method, device and computer-readable storage medium for data migration.

According to a first aspect of embodiments in the present disclosure, a method for data migration is provided. The method may include: triggering a data migration operation in a privacy space having a data migration right; receiving data selected to be migrated; and performing, by using a preset interface provided in the privacy space, the migration operation on the data to be migrated.

According to a second aspect of embodiments in the present disclosure, a device for data migration is provided. The device includes: a processor; a storage for storing instructions executable by the processor; wherein, the processor is configured to: trigger a data migration operation in a privacy space having a data migration right; receive data, selected to be migrated; and perform, by using a preset interface provided in the privacy space, the migration operation on the data to be migrated.

According to a third aspect of the present disclosure, a non-transitory computer-readable storage medium having stored therein instructions is provided. When the instructions are executed by a processor, the processor may be caused to perform: trigger a data migration operation in a privacy space having data migration rights; receive data selected to be migrated; and perform, by using a preset interface provided in the privacy space, the migration operation on the data to be migrated.

It is to be understood that both the forgoing general descriptions and the following detailed descriptions are exemplary and explanatory only, and are not restrictive of the present disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flow chart showing a method for data migration according to an exemplary embodiment;

FIG. 2A is a flow chart showing a method for data migration according to an exemplary embodiment;

FIG. 2B is a schematic diagram showing a data migration interface according to an exemplary embodiment;

FIG. 3 is a block diagram illustrating a device for data migration according to an exemplary embodiment; and

FIG. 4 is a block diagram illustrating a device 400 for data migration according to an exemplary embodiment.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various examples of the present disclosure. Also, common but well-understood elements that are useful or necessary in a commercially feasible example are often not depicted in order to facilitate a less obstructed view of these various examples. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above, except where different specific meanings have otherwise been set forth herein.

### DETAILED DESCRIPTION

For the purposes that the present disclosure, technical solutions and advantages will become more apparent, the implementations of the present disclosure will be further described in detail in conjunction with the accompanying drawings.

Reference will now be made in detail to exemplary embodiments, examples of which are illustrated in the accompanying drawings. The following description refers to the accompanying drawings in which same numbers in different drawings represent same or similar elements unless otherwise described. The implementations set forth in the following description of exemplary embodiments do not represent all implementations consistent with the invention. Instead, they are merely examples of device and methods consistent with aspects related to the invention as recited in the appended claims.

The terminology used in the present disclosure is for the purpose of describing exemplary examples only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if' may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an example is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

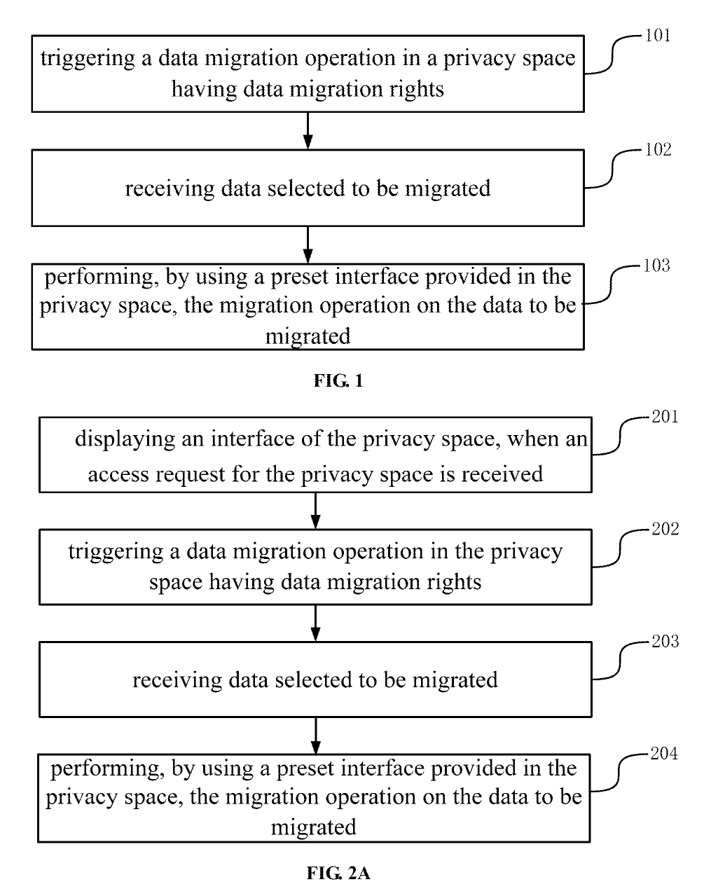

FIG. 1 is a flow chart showing a method for data migration according to an exemplary embodiment. As shown in FIG. 1, the method for data migration, which can be used in a terminal, may include the following steps.

In step 101, data migration operation is triggered in a privacy space having data migration rights.

In step 102, data, which is selected to be migrated, are received.

In step 103, by using a preset interface provided in a privacy space, the migration operation on the data to be migrated is performed.

In the method provided by the embodiment of the present disclosure, by triggering a data migration operation in a privacy space, and by performing, by using a preset interface provided in the privacy space, the migration operation on the data to be migrated, data migration between different spaces on a same terminal can be achieved without using other storage devices as an intermediary, so that a user can select storage space of data as needed, which can not only protect the privacy of user data, but also improve the convenience for user to access data.

In a first potential implementation in the present disclosure, the performing, by using a preset interface provided in the privacy space, the migration operation on the data to be migrated may include: migrating the data to be migrated from a normal space to the privacy space via the preset interface, when the data to be migrated is data in the normal space; migrating the data to be migrated from the privacy space to the normal space via the preset interface, when the data to be migrated is data in the privacy space.

In a second potential implementation in the present disclosure, the preset interface may be a pre-installed system level interface for providing a data channel between the privacy space and the normal space; and the performing, by using a preset interface provided in the privacy space, the migration operation on the data to be migrated may include: determining whether a current space is the privacy space, when the preset interface is invoked for migration operation on the data of the privacy space; invoking the preset interface for migration operation on the data of the privacy space, if the current space is the privacy space; denying invoking of the preset interface for migration operation on the data of the privacy space, if the current space is the normal space.

In a third potential implementation in the present disclosure, triggering the data migration operation in the privacy space may include: logging in the privacy space, when it is necessary to carry out data migrate-in or migrate-out operation on the privacy space; triggering a data migration function in the privacy space to display a data migration interface, where the data migration interface may at least include a data migrate-out option and a data migrate-in option.

In a fourth potential implementation in the present disclosure, receiving the data, which is selected to be migrated, may include: displaying a first data selection interface, when a trigger operation on the data migrate-out option is detected, the first data selection interface may include a data list of the privacy space; receiving a selected first data as the data to be migrated, according to a selection operation by a user in the data list of the privacy space; and accordingly, the performing, by using the preset interface provided in the privacy space, the migration operation on the data to be migrated may include: migrating the data to be migrated from the privacy space to a normal space via the preset interface.

In a fifth potential implementation in the present disclosure, receiving the data, which is selected to be migrated may include: displaying a second data selection interface, when a trigger operation on the data migrate-in option is detected, the second data selection interface may include a data list of the normal space; receiving the selected second data as the data to be migrated, according to a selection operation by the user in the data list of the normal space; and accordingly, performing, by using the preset interface provided in the privacy space, the migration operation on the data to be migrated may include: migrating the data to be migrated from the normal space to the privacy space via the preset interface.

In a sixth potential implementation in the present disclosure, any other space except the privacy space does not have the data migration rights.

In a seventh potential implementation in the present disclosure, prior to triggering the data migration operation in the privacy space, the method may further include: displaying an unlock interface of the privacy space, when an access request for the privacy space is received; receiving a password inputted by a user on the unlock interface of the privacy space; displaying an interface of the privacy space in the case that the password is consistent with an unlock password of the privacy space.

In an eighth potential implementation in the present disclosure, the data migrate-out option may include migrate-out sub-options for multiple types of data, the data migrate-in option may include migrate-in sub-options for multiple types of data, and different types of data may correspond to different storage paths in the privacy space.

All of the above optional technical solutions can be combined in any form to form optional embodiments of the present disclosure, which is not described repeatedly.

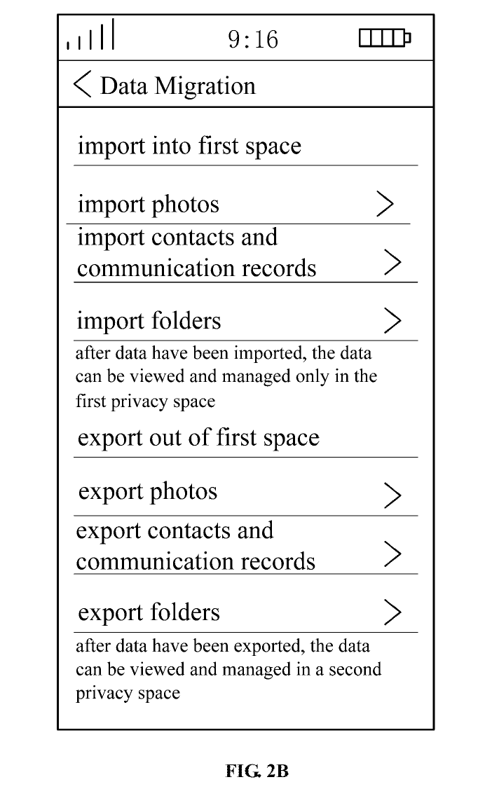

FIG. 2A is a flow chart showing a method for data migration according to an exemplary embodiment. The executive body of the embodiment may be a terminal, which may support a multi-account system. Referring to FIG. 2A, the embodiment particularly may include the following steps.

In step 201, an interface of a privacy space is displayed, when an access request for the privacy space is received.

The interface of the privacy space may at least include a specified application icon, which provides an entry of a data migration function. The data migration function is used for data migration between a privacy space and a normal space. The interface of the privacy space may also include other contents, such as an application icon for system settings. The embodiments of the present disclosure are not particularly limited to any application hereto.

The access request for the privacy space may be triggered by the following ways: the access request for the privacy space is triggered when a trigger operation on a corresponding account name of the privacy space is detected in a space switch interface; or a shortcut icon for accessing the privacy space can also be displayed in any other space interface, and the access request for the privacy space is triggered when a trigger operation on the quick access icon is detected. Other ways can be employed to trigger the access request for the privacy space. The embodiments of the present disclosure are not particularly limited to any type of access request hereto.

Further, the privacy space can be accessed by login with a password. The specific method can be as follows: an unlock interface of the privacy space is displayed, when the access request for the privacy space is received; a password inputted by a user on the unlock interface of the privacy space is received; the privacy space is displayed in the case that the password is consistent with an unlock password of the privacy space. The privacy space must be access by using a password, so security and privacy of a user' data can be further enhanced.

Sometimes, other method for accessing the privacy space may be provided. For example, the finger touch verification may be established and when the request for accessing the privacy space is received, the user may be asked to put a particular finger on the terminal and the terminal may capture and verify the finger image by matching the captured finger image with a pre-captured the finger image the terminal previously obtained and is stored in the terminal, and the privacy space access request may be granted when the currently captured finger image matches the previously obtained finger image.

In another embodiment of the present disclosure, the privacy space is used for storing privacy data of a user or data that the user wants to hide, the normal space is used for storing data of lower privacy. Each of the privacy space and the normal space can be a space set by a user, or a default space set by the system. The embodiments of the present disclosure are not limited to any specific way to set the normal space and privacy space hereto. It should be noted that the user can view the data in the normal space and cannot view the data in the privacy space when a current space of a terminal is the normal space; and the user can view both the data in the normal space and in the privacy space when the current space of a terminal is the privacy space.

As such, the privacy space may be a storage space in a terminal that may store data that the user may not want to be viewed or accessed without certain restrictions. The certain restrictions may include both password verification and/or finger print verification. After the restrictions are met, the data stored in the privacy space may be viewed and accessed by the user. On the other hand, the data stored in normal space may be viewed and/or accessed by the user when the user is able to access the terminal.

Sometimes, the normal space and the privacy space on a terminal may be exchangeable. For example, a file may be created on a normal space and the file stores unimportant information initially. However, later, the user may start to add the important financial information and/or important client information to the file and the user may not want the file to be accessed and viewed as a normal space. As such, the user may be able to change the storage space where the file is stored from the normal space to be the privacy space and the file thus may not be accessed and viewed without first obtaining the accessing right to the privacy space by typing the password and/or going through the finger touch verification. The normal space may therefore be changed to be the privacy space. The privacy space may also be changed to be the normal space by using a similar process which is not elaborated herein.

The privacy space is used for storing privacy data of a user or data that the user wants to hide and the normal space is used for storing data of lower privacy, so security of privacy data can further improved.

In step 202, a data migration operation in the privacy space is triggered. The privacy space has data migration rights.

The data migration operation can be triggered as follows: an option for providing data migration function is displayed in the interface of the privacy space, and the data migration function can be triggered when a data trigger operation on the option is detected. The data trigger operation can be triggered in any of other ways. For example, when the terminal is a terminal having a touch screen, the data migration operation can be triggered if a specified gesture inputted by a user in a terminal interface is detected. The specified gesture may be a three-finger-grabbing gesture, which is a quick way to trigger the data migration operation. The specified gesture may be any other gesture, and the embodiments of the present disclosure are not particularly limited to any gesture hereto.

The privacy space should be logged in when it is necessary to carry out data migrate-in or migrate-out operation on the privacy space. Then a data migration function is triggered in the privacy space to display a data migration interface. The data migration interface may include at least a data migrate-out option and a data migrate-in option. The data migrate-out option is used for migrating data in the privacy space to the normal space, and the data migrate-in option is used for migrating data in the normal space to the privacy space. Besides the data migrate-out option and the data migrate-in option, the data migration interface may further include other information, such as guidelines for data migration, etc. The embodiments of the present disclosure are not particularly limited to any specific information hereto.

The data migrate-out option may include migrate-out sub-options for multiple types of data, and the data migrate-in option may include migrate-in sub-options for multiple types of data. Different types of data may correspond to different storage paths in the space. That is, each migrate-out sub-option for a corresponding type of data may be used for migration of the corresponding type of data from the privacy space to the normal space; and accordingly, each migrate-in sub-option for a corresponding type of data type may be used for migration of the corresponding type of data from the normal space to the privacy space.

The multiple types of data may include photos, contacts and communication records, and may also include a migratable folder, and any other data that can be migrated between two spaces. The embodiments of the present disclosure are not particularly limited to any type of data hereto.

FIG. 2B is a schematic diagram showing a data migration interface according to an exemplary embodiment. In FIG. 2B, “import photos”, “import contacts and communication records” and “import folders” are migrate-in sub-options for corresponding types of data respectively, and are used for migration of photos, contacts and communication records and folders in other space from the normal space to the privacy space; and “export photos”, “export contacts and communication records” and “export folders” are migrate-out sub-options for corresponding types of data respectively, and are used for migration of photos, contacts and communication records and folders from the privacy space to a normal space.

In addition, in FIG. 2B, the data migration interface can also display a prompt message for prompting the user that: after data have been migrated into the privacy space, the data can be viewed and managed only in the privacy space; after data have been migrated out of the privacy space, the data can be viewed and managed in the space, into which the data has been migrated. The migration interface may include other information. The embodiments of the present disclosure are not particularly limited to any specific information hereto.

In another embodiment of the present disclosure, other spaces except the privacy space may not have the data migration rights. That is, when the specified application icon is displayed in the interface of the privacy space, if the current space of the terminal is the privacy space, and a trigger operation on the specified application icon is detected, a data migration interface is displayed to attain migration of data from a normal space into the privacy space or migration of data from the privacy space into the normal space. If the current space of the terminal is the normal space, the specified application icon may not be displayed in the interface of the normal space, that is, the user cannot perform in the normal space a data migration operation between different spaces on the same terminal. With the above method, a data migration operation can only be performed in the privacy space, and thus through migration of the data from the privacy space into the normal space, it is convenient for user to use, manage or access the data; and through migration of data from the normal space into the privacy space, security of the data can be enhanced, and hence privacy of the user's data can be further enhanced.

As described above, the data migration interface may be displayed upon the detection of a trigger operation and the data migration interface may accept the data migration options from the user and the data migration may be performed accordingly. Sometimes, the data migration may be performed right after the data migration options are provided via the data migration interface. Sometimes, the data migration may be performed at a later time. When the data migration is performed at a later time, the data migration interface may provide an option for the user to select and/or enter the time when the data migration is performed. As such, for a big volume of data to be migrated from the privacy space to the normal space or vice versa, the data migration may be scheduled to be performed when the terminal is not used heavily, for example, at a night time. By this way, the impact of the data migration to the normal use of the terminal may be reduced.

It should be noted that a terminal may include multiple privacy spaces, and each privacy space may be set by a user for storing different types of data. For example, a first privacy space may be used for storing photos, a second privacy space may be used for storing contacts and communication records. Accordingly, the terminal may also include multiple normal spaces. Regarding the number of the privacy spaces and the normal spaces, the embodiments of the present disclosure are not limited to any number of spaces thereto.

By setting multiple privacy spaces for storing different types of data respectively, separate managements of different types of data can be achieved.

In step 203, the data, which is selected to be migrated, is received.

In the case that the data migration interface includes a data migrate-out option and a data migrate-in option, reception of the data which is selected to be migrated can be implemented by the following two methods.

Method 1: a first data selection interface is displayed, when a trigger operation on the data migrate-out option is detected. The first data selection interface may include a data list of the privacy space. Then, a selected first data is received as the data to be migrated according to a selection operation by the user in the data list of the privacy space.

The data migrate-out option may include migrate-out sub-options for multiple types of data, and in this case, when a trigger operation on a migrate-out sub-option for any type of data is detected, a data list of that type of data in the privacy space is displayed. For example, if the type of data is a photo, then when a trigger operation on the migrate-out sub-option for photos is detected, a list of photos stored in the privacy space may be displayed for to user to select a photo to be migrated. As shown in FIG. 2B, when a trigger operation on the option “export photos” in the figure is detected, a list of the photos in the privacy space may be displayed for the user to select a photo to be migrated out. When a selection operation on any data in the data list of the privacy space is detected, the data are received as the data to be migrated.

By detecting a trigger operation on a migrate-out sub-options of a different type of data and displaying a data list corresponding to that type of data accordingly, the user is able to find out the data to be migrated quickly, and thus convenience of data migration can be enhanced.

Method 2, a second data selection interface is displayed when a trigger operation on the data migrate-in option is detected. The second data selection interface may include a data list of the normal space. A selected second data is received as the data to be migrated according to a selection operation by the user in the data list of the normal space.

The data migrate-in option may include migrate-in sub-options for multiple types of data, and in this case, when a trigger operation on a migrate-in sub-option for any type of data is detected, a data list of that type of data in a storage space corresponding to the normal space is displayed. For example, if the type of data is a photo, then when a trigger operation on a migrate-in sub-option for photos is detected, a list of photos stored in the storage space corresponding to the normal space may be displayed for the user to select a photo to be migrated. As shown in FIG. 2B, when a trigger operation on the option “export photos” in the figure is detected, a list of photos in the privacy space may be displayed for the user to select a photo to be migrated into the privacy space.

By detecting a trigger operation on a migrate-in sub-option of a different type of data, and displaying a data list corresponding to that type of data accordingly, the user is able to find out the data to be migrated quickly, and thus convenience of data migration can be enhanced.

In step 204, the migration operation on the data to be migrated is performed by using a preset interface provided in the privacy space.

The preset interface is used for migration of data in a privacy space to a normal space and migration of data in a normal space to a privacy space.

In another embodiment of the present disclosure, in order to further enhance the security, a preset interface for providing a data channel between the privacy space and the normal space may be a preset system-level interface. The preset interface can only be invoked in the privacy space, but may not be invoked in the normal space.

The preset interface is a preset system-level interface for providing a data channel between the privacy space and the normal space. A determination as to whether the current space is the privacy space is made when the preset interface is invoked for migration operation on the data of the privacy space. The preset interface is invoked for migration operation on the data of the privacy space, if the current space is the privacy space; and the preset interface may be denied to be invoked for migration operation on the data of the privacy space, if the current space is the normal space. That is, when the current space of the terminal is a privacy space, data migration between different spaces can be achieved by invoking of the preset interface; and when the current space of a terminal is a normal space, the preset interface cannot be invoked and data migration between different spaces cannot be achieved.

The data to be migrated may be migrated from a normal space to the privacy space via the preset interface, when the data to be migrated is the data in the normal space; and the data to be migrated may be migrated from the privacy space to the normal space via the preset interface, when the data to be migrated is the data in the privacy space.

Specifically, when a selection operation on any data in the data list of the privacy space is detected, the data to be migrated may be migrated from the privacy space to the normal space via the preset interface. It should be noted that, migration of the data to be migrated from the privacy space to the normal space means that the data may be stored in the normal space and deleted from the privacy space. Sometimes, it is possible the data to be migrated is stored in both the privacy space and the normal space after the data is migrated.

For migration of data from the privacy space to the normal space, the data in the data list of the privacy space can be migrated by one piece at a time, or by multiple pieces at a time. A “select all” option can be displayed on the top or bottom of the displayed data list, and in this case, when a trigger operation on the “select all” option is detected and confirmation of the migration operation is detected, all of data are migrated from the privacy space to the normal space at the same time. The embodiments of the present disclosure are not particularly limited to any specific selection method hereto.

In another embodiment, the current terminal may include multiple normal spaces in addition to the privacy space. In such a case, during migrate-out process, when the data to be migrated is determined, a target normal space should be determined according to selection by the user among the multiple normal spaces, and then the data may be migrated to the target normal space, and thereby data migration on a terminal having multiple normal spaces can be achieved.

The method for migrating the data to be migrated from the normal space to the privacy space via the preset interface is same as the above method for migrating the data to be migrated from the privacy space to the normal space via the preset interface, and thus may be not repeated here.

In the methods provided by the embodiments of the present disclosure, by triggering a data migration operation in a privacy space and by performing, by using a preset interface provided in the privacy space, the migration operation on the data to be migrated, data migration between different spaces on a same terminal can be achieved without other storage devices as an intermediary, so that a user can select a storage space for data as needed, which can not only protect privacy of the user's data, but also improve convenience for the user to access the data. Moreover, since the privacy space may be accessed by using a password and/or some security means, security and privacy of the user's data can be further enhanced.

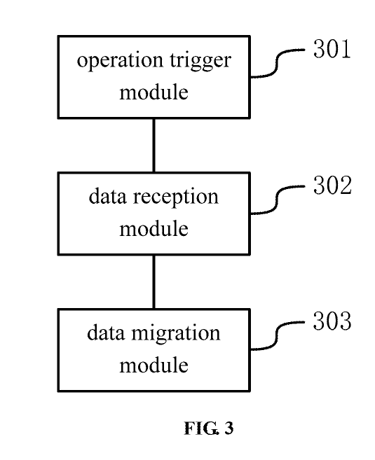

FIG. 3 is a block diagram illustrating a device for data migration according to an exemplary embodiment. Referring to FIG. 3, the device includes an operation trigger module 301, a data reception module 302 and a data migration module 303.

The operation trigger module 301 may be configured to trigger a data migration operation in a privacy space having data migration rights. The data reception module 302 may be configured to receive data selected to be migrated. The data migration module 303 may be configured to perform, by using a preset interface provided in the privacy space, the migration operation on the data to be migrated.

In a first potential implementation in the present disclosure, the data migration module 303 may be configured to: migrate the data to be migrated from a normal space to the privacy space via the preset interface, when the data to be migrated is data in the normal space; migrate the data to be migrated from the privacy space to the normal space via the preset interface, when the data to be migrated is data in the privacy space.

In a second potential implementation in the present disclosure, the preset interface may be a pre-installed system level interface for providing a data channel between the privacy space and the normal space. The data migration module 303 may be configured to: determine whether a current space is the privacy space, when the preset interface is invoked for migration operation on the data of the privacy space; invoke the preset interface for migration operation on the data of the privacy space, if the current space is the privacy space; deny invoking of the preset interface for migration operation on the data of the privacy space, if the current space is the normal space.

In a third potential implementation in the present disclosure, the operation trigger module 301 may be configured to: log in the privacy space, when it is necessary to carry out data migrate-in or migrate-out operation on the privacy space; and trigger a data migration function in the privacy space to display a data migration interface, the data migration interface may at least include a data migrate-out option and a data migrate-in option.

In a fourth potential implementation in the present disclosure, the data reception module 302 may be configured to: display a first data selection interface, when a trigger operation on the data migrate-out option is detected, the first data selection interface may include a data list of the privacy space; receive the selected first data as the data to be migrated, according to a selection operation by a user in the data list of the privacy space; and accordingly, the data migration module 303 may be configured to migrate the data to be migrated from the privacy space to the normal space via the preset interface.

In a fifth potential implementation in the present disclosure, the data reception module 302 may be configured to: display a second data selection interface, when a trigger operation on the data migrate-in option is detected, the second data selection interface may include a data list of the normal space; receive the selected second data as the data to be migrated, according to a selection operation by the user in the data list of the normal space; and accordingly, the data migration module 303 may be configured to migrate the data to be migrated from the normal space to the privacy space via the preset interface.

In a sixth potential implementation in the present disclosure, any other space except the privacy space does not have the data migration rights. As such, the privacy space may be the only space that has the data migration right.

In a seventh potential implementation in the present disclosure, the device may further include: a display module configured to display an unlock interface of the privacy space, when an access request for the privacy space is received; a password reception module configured to receive a password inputted by a user on the unlock interface of the privacy space; the display module may also be configured to display the privacy space, in the case that the password is consistent with an unlock password of the privacy space.

In an eighth potential implementation in the present disclosure, the data migrate-out option may include migrate-out sub-options for multiple types of data, the data migrate-in option may include migrate-in sub-options for multiple types of data, and different types of data may correspond to different storage paths in the privacy space.

The implementation procedures of functions and features of respective modules of the device are same as those in respective steps of the above methods, and thus may be not repeated here.

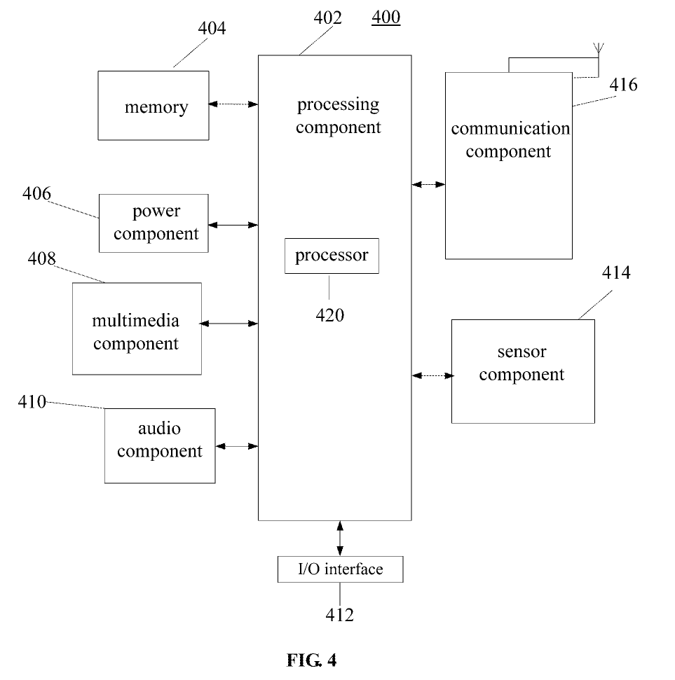

FIG. 4 is a block diagram illustrating a device 400 for data migration according to an exemplary embodiment. For example, the device 400 may be a mobile phone, a computer, a digital broadcast terminal, a message transceiver, a game console, a tablet device, a medical equipment, a fitness equipment, a personal digital assistant, and the like.

Referring to FIG. 4, the device 400 may include one or more of the following components: a processing component 402, a memory 404, a power component 406, a multimedia component 408, an audio component 410, an input/output (I/O) interface 412, a sensor component 414, and a communication component 416.

The processing component 402 typically controls overall operations of the device 400, such as the operations associated with display, telephone calls, data communications, camera operations, and recording operations. The processing component 402 may include one or more processors 420 to execute instructions to perform all or part of the steps in the above described methods. Moreover, the processing component 402 may include one or more modules which facilitate the interaction between the processing component 402 and other components. For instance, the processing component 402 may include a multimedia module to facilitate the interaction between the multimedia component 408 and the processing component 402.

The memory 404 may be configured to store various types of data to support the operation of the device 400. Examples of such data may include instructions for any applications or methods operated on the device 400, contact data, phonebook data, messages, pictures, video, etc. The memory 404 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 406 provides power to various components of the device 400. The power component 406 may include a power management system, one or more power sources, and any other components associated with the generation, management, and distribution of power in the device 400.

The multimedia component 408 includes a screen providing an output interface between the device 400 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also detect a period of time and a pressure associated with the touch or swipe action. In some embodiments, the multimedia component 408 includes a front camera and/or a rear camera. The front camera and/or the rear camera may receive an external multimedia datum while the device 400 is in an operation mode, such as a photographing mode or a video mode. Each of the front camera and the rear camera may be a fixed optical lens system or have focus and optical zoom capability.

The audio component 410 may be configured to output and/or input audio signals. For example, the audio component 410 includes a microphone (“MIC”) configured to receive an external audio signal when the device 400 is in an operation mode, such as a call mode, a recording mode, and a voice recognition mode. The received audio signal may be further stored in the memory 404 or transmitted via the communication component 416. In some embodiments, the audio component 410 further includes a speaker to output audio signals.

The I/O interface 412 provides an interface between the processing component 402 and peripheral interface modules, such as a keyboard, a click wheel, buttons, and the like. The buttons may include, but are not limited to, a home button, a volume button, a starting button, and a locking button.

The sensor component 414 includes one or more sensors to provide status assessments of various aspects of the device 400. For instance, the sensor component 414 may detect an open/closed status of the device 400, relative positioning of components, e.g., the display and the keypad, of the device 400, a change in position of the device 400 or a component of the device 400, a presence or absence of user contact with the device 400, an orientation or an acceleration/deceleration of the device 400, and a change in temperature of the device 400. The sensor component 414 may include a proximity sensor configured to detect the presence of nearby objects without any physical contact. The sensor component 414 may also include a light sensor, such as a CMOS or CCD image sensor, for use in imaging applications. In some embodiments, the sensor component 414 may also include an accelerometer sensor, a gyroscope sensor, a magnetic sensor, a distance sensor, a pressure sensor, or a temperature sensor.

The communication component 416 may be configured to facilitate communication, wired or wirelessly, between the device 400 and other devices. The device 400 can access a wireless network based on a communication standard, such as WiFi, 2G or 3G; or a combination thereof. In one exemplary embodiment, the communication component 416 receives a broadcast signal or broadcast associated information from an external broadcast management system via a broadcast channel. In one exemplary embodiment, the communication component 416 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 400 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as the memory 404 including instructions executable by the processor 420 in the device 400 to perform the above-described methods. For example, the non-transitory computer-readable storage medium may be a ROM, a RAM, a CD-ROM, a magnetic tape, a floppy disc, an optical data storage device, and the like.

In exemplary embodiments, there is also provided a non-transitory computer-readable storage medium including instructions that, when executed by a processor of a mobile terminal, enables the mobile terminal to perform the above-described method for data migration.

According to one aspect of embodiments in the present disclosure, a device for data migration is provided. The device may include: an operation trigger module configured to trigger a data migration operation in a privacy space having data migration rights; a data reception module configured to receive data selected to be migrated; and a data migration module configured to perform, by using a preset interface provided in the privacy space, the migration operation on the data to be migrated.

Other embodiments of the invention may be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. The specification and embodiments are merely considered to be exemplary and the substantive scope and spirit of the disclosure is limited only by the appended claims.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “unit,” or “sub-unit” may include memory (shared, dedicated, or group) that stores code or instructions that can be executed by one or more processors.

It should be understood that the disclosure is not limited to the precise structure as described above and shown in the figures, but can have various modification and alternations without departing from the scope of the disclosure. The scope of the disclosure is limited only by the appended claims.

What is claimed is:

1. A method for data migration, comprising:
triggering a data migration operation in a privacy space having a data migration right;
receiving data selected to be migrated; and
performing, by using a preset interface provided in the privacy space, the migration operation on the data to be migrated.

2. The method of claim 1, wherein performing, by using the preset interface provided in the privacy space, the migration operation on the data to be migrated comprises:
migrating the data to be migrated from a normal space to the privacy space via the preset interface, when the data to be migrated is the data in the normal space; and
migrating the data to be migrated from the privacy space to the normal space via the preset interface, when the data to be migrated is the data in the privacy space.

3. The method of claim 1, wherein the preset interface is a pre-installed system level interface for providing a data channel between the privacy space and the normal space; and
wherein performing, by using the preset interface provided in the privacy space, the migration operation on the data to be migrated comprises:
determining whether a current space is the privacy space, when the preset interface is invoked for migration operation on the data of the privacy space;
invoking the preset interface for migration operation on the data of the privacy space if the current space is the privacy space; and
denying invoking of the preset interface for migration operation on the data of the privacy space if the current space is a normal space.

4. The method of claim 1, wherein triggering the data migration operation in the privacy space comprises:
logging in the privacy space when it is necessary to carry out a data migrate-in or migrate-out operation on the privacy space; and
triggering a data migration function in the privacy space to display a data migration interface, wherein the data migration interface includes at least the data migrate-out option and the data migrate-in option.

5. The method of claim 4, wherein receiving the data selected to be migrated comprises:
displaying a first data selection interface when a trigger operation on the data migrate-out option is detected, wherein the first data selection interface comprises a data list of the privacy space;
receiving a selected first data as the data to be migrated according to a selection operation by a user in the data list of the privacy space; and
wherein performing, by using the preset interface provided in the privacy space, the migration operation on the data to be migrated comprises:
migrating the data to be migrated from the privacy space to a normal space via the preset interface.

6. The method of claim 4, wherein receiving the data selected to be migrated, comprises:
displaying a second data selection interface, when a trigger operation on the data migrate-in option is detected, wherein the second data selection interface comprises a data list of a normal space;
receiving a selected second data as the data to be migrated according to a selection operation by a user in the data list of the normal space; and
wherein the performing, by using the preset interface provided in the privacy space, the migration operation on the data to be migrated comprises:
migrating the data to be migrated from the normal space to the privacy space via the preset interface.

7. The method of claim 1, wherein any other space except the privacy space does not have the data migration right.

8. The method of claim 1, wherein, prior to triggering the data migration operation in the privacy space, the method further comprises:
displaying an unlock interface of the privacy space, when an access request for the privacy space is received;
receiving a password inputted by a user on the unlock interface of the privacy space; and
displaying an interface of the privacy space in the case that the password is consistent with the password for the privacy space.

9. The method of claim 4, wherein the data migrate-out option comprises migrate-out sub-options for multiple types of data, and the data migrate-in option comprises migrate-in sub-options for multiple types of data, and different types of data correspond to different storage paths in the privacy space.

10. A device for data migration, comprising:
a processor;
a storage for storing instructions executable by the processor;
wherein the processor is configured to:
trigger a data migration operation in a privacy space having a data migration right;
receive data selected to be migrated; and
perform, by using a preset interface provided in the privacy space, the migration operation on the data to be migrated.

11. The device of claim 10, wherein the processor is further configured to:
migrate the data to be migrated from a normal space to the privacy space via the preset interface, when the data to be migrated is the data in the normal space; and
migrate the data to be migrated from the privacy space to the normal space via the preset interface, when the data to be migrated is the data in the privacy space.

12. The device of claim 10, wherein the preset interface is a pre-installed system level interface for providing a data channel between the privacy space and the normal space; and the processor is further configured to:
determine whether a current space is the privacy space when the preset interface is invoked for migration operation on the data of the privacy space;
invoke the preset interface for migration operation on the data of the privacy space if the current space is the privacy space; and
deny invoking of the preset interface for migration operation on the data of the privacy space if the current space is a normal space.

13. The device of claim 10, wherein the processor is further configured to:
log in the privacy space when it is necessary to carry out a data migrate-in or migrate-out operation on the privacy space; and
trigger a data migration function in the privacy space to display a data migration interface, wherein the data migration interface at least comprises the data migrate-out option and the data migrate-in option.

14. The device of claim 13, wherein the processor is further configured to:
display a first data selection interface when a trigger operation on the data migrate-out option is detected, wherein the first data selection interface comprises a data list of the privacy space;
receive a selected first data as the data to be migrated according to a selection operation selected by a user in the data list of the privacy space; and
migrate the data to be migrated from the privacy space to a normal space via the preset interface.

15. The device of claim 13, wherein the processor is further configured to:
display a second data selection interface, when a trigger operation on the data migrate-in option is detected, wherein the second data selection interface comprises a data list of the normal space;
receive a selected second data as the data to be migrated according to a selection operation by a user in the data list of the normal space; and
migrate the data to be migrated from the normal space to the privacy space via the preset interface.

16. The device of claim 10, wherein any other space except the privacy space does not have the data migration right.

17. The device of claim 10, wherein the processor is further configured to:
display an unlock interface of the privacy space, when an access request for the privacy space is received;
receive a password inputted by a user on the unlock interface of the privacy space;
display an interface of the privacy space in the case that the password is consistent with the password for the privacy space

18. The device of claim 13, wherein the data migrate-out option comprises migrate-out sub-options for multiple types of data, the data migrate-in option comprises migrate-in sub-options for multiple types of data, and different types of data correspond to different storage paths in the privacy space.

19. A non-transitory computer-readable storage medium having stored therein instructions that, when executed by a processor of a device, cause the device to perform:
trigger a data migration operation in a privacy space having a data migration right;
receive data selected to be migrated; and
perform, by using a preset interface provided in the privacy space, the migration operation on the data to be migrated.
